(19) United States
(12) Patent Application Publication
(10) Pub. No.: US 2026/0221495 A1
(43) Pub. Date: Jul. 30, 2026

(54) ALL-SOLID-STATE BATTERY

(71) Applicant: LG ELECTRONICS INC., Seoul (KR)

(72) Inventor: Byungjoon RHEE, Seoul (KR)

(73) Assignee: LG ELECTRONICS INC., Seoul (KR)

(21) Appl. No.: 19/145,402

(22) PCT Filed: Jan. 3, 2023
(86) PCT No.: PCT/KR2023/000067

§ 371 Date: Jul. 2, 2025

(51) Int. Cl. H01M 10/0562; H01M 10/0525; H01M 10/0585; H01M 50/474

(52) U.S. Cl. CPC H01M 10/0562; H01M 10/0585; H01M 50/474; H01M 10/0525

(57) ABSTRACT

The present disclosure relates to an all-solid-state battery that can be applied to a secondary battery and that is, for example, a secondary battery using a solid electrolyte. The present disclosure provides an all-solid-state battery using a solid electrolyte, comprising: a first electrode layer; a second electrode layer positioned to face the first electrode layer; a first battery region defined between the first electrode layer and the second electrode layer; a second battery region defined in a position adjacent to the first battery region between the first electrode layer and the second electrode layer; and a cathode layer positioned in the first battery region and the second battery region.

### TECHNICAL FIELD

The present disclosure relates to an all-solid-state battery that is applicable to a secondary battery and that is, for example, a secondary battery using a solid electrolyte.

### BACKGROUND ART

Rechargeable secondary batteries are widely used as high-capacity power storage batteries for applications such as electric vehicles or energy storage systems, and as compact, high-performance energy sources for portable electronic devices such as mobile phones, camcorders, and laptop computers.

Among secondary batteries, lithium-ion batteries offer advantages in terms of ease of use compared to nickel-manganese batteries or nickel-cadmium batteries, due to their higher capacity per unit area, lower self-discharge rate, and absence of a memory effect.

A lithium-ion battery includes a carbon-based negative electrode, an electrolyte containing an organic solvent, and a lithium oxide positive electrode. The lithium-ion battery is characterized in that, during charging, lithium ions are released from the positive electrode and migrate to the carbon-based negative electrode through the electrolyte by chemical reactions occurring at the positive and negative electrodes, and during discharging, the reverse process of charging occurs.

However, because a lithium-ion battery uses a liquid electrolyte containing an organic solvent, there are various concerns regarding battery stability, such as leakage due to use of the highly volatile organic solvent and damage resulting from impact.

Therefore, in order to ensure the safety of a lithium-ion battery, research is being actively conducted on all-solid-state batteries that use a solid electrolyte instead of a liquid electrolyte.

Because such an all-solid-state battery does not use a flammable organic solvent within the battery, it may be possible to simplify safety devices, and it may be advantageous in terms of manufacturing cost or productivity. In addition, all-solid-state batteries using a sulfide-based solid electrolyte may offer the advantage of excellent lithium-ion conductivity.

However, all-solid-state batteries have limitations in terms of energy density and output performance compared to conventional lithium-ion batteries that use a liquid electrolyte. Therefore, improvements are required in various aspects, including materials and structural design, in order to overcome such limitations.

FIG. 1 is a view schematically showing the configuration of a general all-solid-state battery. A general all-solid-state battery broadly includes a positive electrode layer (or cathode layer) 10, a solid electrolyte layer 20, and a negative electrode layer (or anode layer) 30. The positive electrode layer 10, the solid electrolyte layer 20, and the negative electrode layer 30 may be disposed between a first electrode 40 and a second electrode 50.

The positive electrode layer 10 may include a positive electrode active material (a positive electrode material or cathode material) 11 and a solid electrolyte 12, and may further include a conductive material (not shown) and a binder 13.

The solid electrolyte layer 20 may include a solid electrolyte 21.

Similar to the positive electrode layer 10, the negative electrode layer 30 may include a negative electrode active material 31. In addition, the negative electrode layer 30 may further include a conductive material and a binder.

Such an all-solid-state battery is a battery system in which an organic electrolyte of a commercial lithium secondary battery is replaced with a solid electrolyte, and employs materials having high conductivity and flame retardancy, thereby providing not only enhanced safety but also high energy density and high output density.

Unlike liquid-based batteries, all-solid-state batteries employ a solid electrolyte, which also serves as a separator. In addition, by fabricating high-voltage unit cells using a bipolar stacking method, it may be possible to simplify the battery pack structure, thereby implementing a battery system having a simpler structure than conventional lithium-ion batteries.

However, due to electrochemical side reactions during initial charging and discharging, mobile lithium participating in reversible reactions is consumed, and the number of effective lithium ions rapidly decreases even during the first discharging, leading to reduction in electrode energy.

Accordingly, voids are likely to be formed between active material particles and the electrolyte. As a result, the volume of the battery may increase, and the interfacial resistance between the active material particles and the electrolyte may increase.

Therefore, there is a need for a solution to address these issues.

### DISCLOSURE

### Technical Problem

An aspect of the present disclosure is to provide an all-solid-state battery capable of addressing various interfacial issues that may occur in all-solid-state batteries.

In one example, there is provided an all-solid-state battery capable of alleviating the formation of voids between a positive electrode active material and an electrolyte.

In addition, there is provided an all-solid-state battery capable of alleviating the formation of an interface between a positive electrode active material and a positive electrode.

In addition, there is provided an all-solid-state battery capable of alleviating the formation of voids between a negative electrode active material and an electrolyte.

In addition, there is provided an all-solid-state battery capable of alleviating the formation of an interface between a negative electrode active material and a negative electrode.

### Technical Solutions

In accordance with a first aspect for accomplishing the above objects, an all-solid-state battery using a solid electrolyte of the present disclosure includes a first electrode layer, a second electrode layer disposed opposite the first electrode layer, a first battery region defined between the first electrode layer and the second electrode layer, a second battery region defined between the first electrode layer and the second electrode layer at a position adjacent to the first battery region, and a positive electrode layer disposed in the first battery region and the second battery region.

In an exemplary embodiment, the first battery region and the second battery region may be repeatedly provided in a direction parallel to the first electrode layer or the second electrode layer.

In an exemplary embodiment, a pair of the first battery region and the second battery region may be defined by a first partition wall extending from one of the first electrode and the second electrode.

In an exemplary embodiment, the first partition wall may be formed to be connected to the first electrode.

In an exemplary embodiment, a negative electrode material (or an anode material) may be disposed between the first battery region and the second battery region.

In an exemplary embodiment, the negative electrode material may be disposed in the form of a partition wall between the first electrode layer and the second electrode layer.

In an exemplary embodiment, the negative electrode material may be disposed on a second partition wall connected to the second electrode layer.

In an exemplary embodiment, at least one of the first battery region or the second battery region may be defined between the negative electrode material and the first partition wall.

In an exemplary embodiment, stress generated during charging and discharging may be offset in at least one of the first partition wall or the negative electrode material.

In an exemplary embodiment, an electrolyte layer may be disposed on at least one side surface of the negative electrode material.

In an exemplary embodiment, an insulating adhesive layer may be disposed between the first electrode layer and the negative electrode material.

In an exemplary embodiment, an insulating layer may be disposed on the second electrode layer.

In an exemplary embodiment, the positive electrode layer may include a positive electrode material (or a cathode material) in contact with an electrolyte.

In an exemplary embodiment, at least one of the electrolyte or the positive electrode material may be disposed on an elastic core.

In an exemplary embodiment, the elastic core may include polymer particles.

In accordance with a second aspect for accomplishing the above objects, an all-solid-state battery using a solid electrolyte of the present disclosure includes a first electrode layer, a second electrode layer disposed opposite the first electrode layer, a first partition wall dividing a space between the first electrode layer and the second electrode layer in one direction, a first battery region defined on one side of the first partition wall, a second battery region defined on the other side of the first partition wall at a position adjacent to the first battery region, and a positive electrode layer disposed in the first battery region and the second battery region.

### Advantageous Effects

According to an embodiment of the present disclosure, the following effects may be achieved.

First, according to the embodiment of the present disclosure, the formation of voids between the positive electrode active material and the electrolyte may be alleviated, thereby mitigating increase in interfacial resistance of the positive electrode active material.

In addition, increase in interfacial resistance between the positive electrode active material and the positive electrode may be alleviated.

In addition, increase in interfacial resistance between the negative electrode active material and the electrolyte may be alleviated.

In addition, increase in interfacial resistance between the negative electrode active material and the negative electrode may be alleviated.

Furthermore, according to the embodiment of the present disclosure, additional technical effects not mentioned herein may also be exhibited. This will be understood by those skilled in the art from the entirety of the specification and the drawings.

### DESCRIPTION OF DRAWINGS

FIG. 1 is a view schematically showing the configuration of a general all-solid-state battery.

FIG. 2 is a cross-sectional view schematically showing the configuration of an all-solid-state battery applicable to the present disclosure.

FIG. 3 is a cross-sectional view schematically showing an expansion phenomenon caused by voids in the all-solid-state battery applicable to the present disclosure.

FIG. 4 is a conceptual view showing an all-solid-state battery according to an embodiment of the present disclosure.

FIG. 5 is a cross-sectional view showing an all-solid-state battery according to an embodiment of the present disclosure.

FIG. 6 is a cross-sectional view showing a positive electrode layer of the all-solid-state battery according to an embodiment of the present disclosure.

FIG. 7 is a cross-sectional view showing a stress offset process in the all-solid-state battery according to an embodiment of the present disclosure.

FIGS. 8 to 14 are schematic cross-sectional views showing a process of manufacturing the all-solid-state battery according to an embodiment of the present disclosure.

FIG. 15 is a schematic cross-sectional view showing a portion of an all-solid-state battery according to another embodiment of the present disclosure.

### BEST MODE FOR DISCLOSURE

Reference will now be made in detail to embodiments of the present disclosure, examples of which are illustrated in the accompanying drawings. Wherever possible, the same reference numbers will be used throughout the drawings to refer to the same or like parts, and redundant description thereof will be omitted. As used herein, the suffixes “module” and “unit” are added or used interchangeably to facilitate preparation of this specification and are not intended to suggest distinct meanings or functions.

In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification.

Furthermore, although the drawings are separately described for simplicity, embodiments implemented by combining at least two or more drawings are also within the scope of the present disclosure.

In addition, when an element such as a layer, region or module is described as being “on” another element, it is to be understood that the element may be directly on the other element or there may be an intermediate element between them.

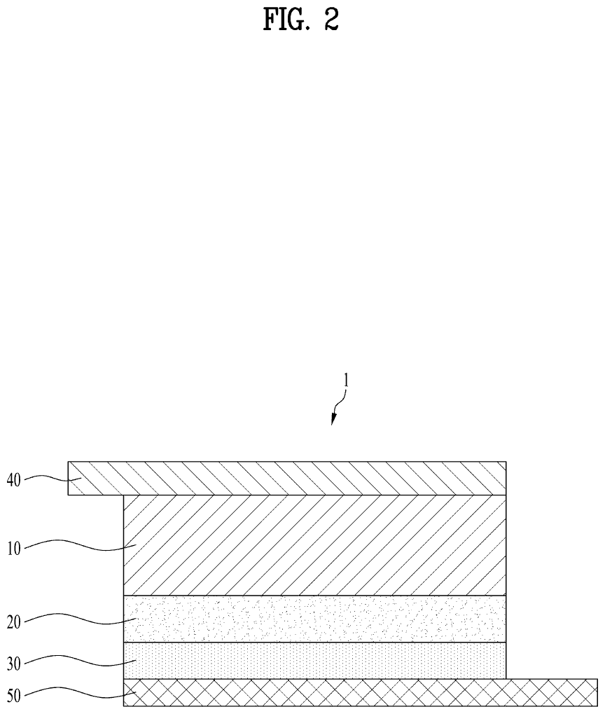

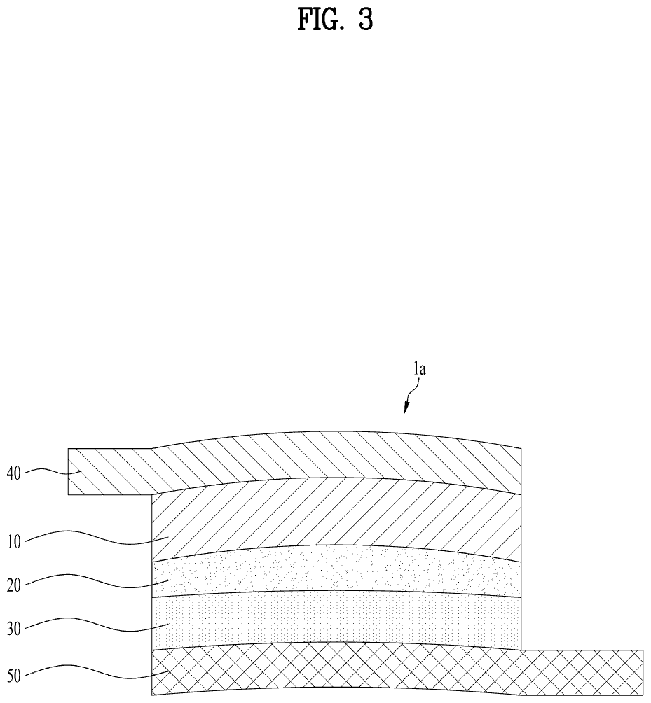

FIG. 2 is a cross-sectional view schematically showing the configuration of an all-solid-state battery applicable to the present disclosure. FIG. 3 is a cross-sectional view schematically showing an expansion phenomenon caused by voids in the all-solid-state battery applicable to the present disclosure.

Referring to FIG. 2, the all-solid-state battery applicable to the present disclosure broadly includes a positive electrode layer 10, a solid electrolyte layer 20, and a negative electrode layer 30. The positive electrode layer 10, the solid electrolyte layer 20, and the negative electrode layer 30 may be disposed between a first electrode (a first current collector) 40 and a second electrode (a second current collector) 50.

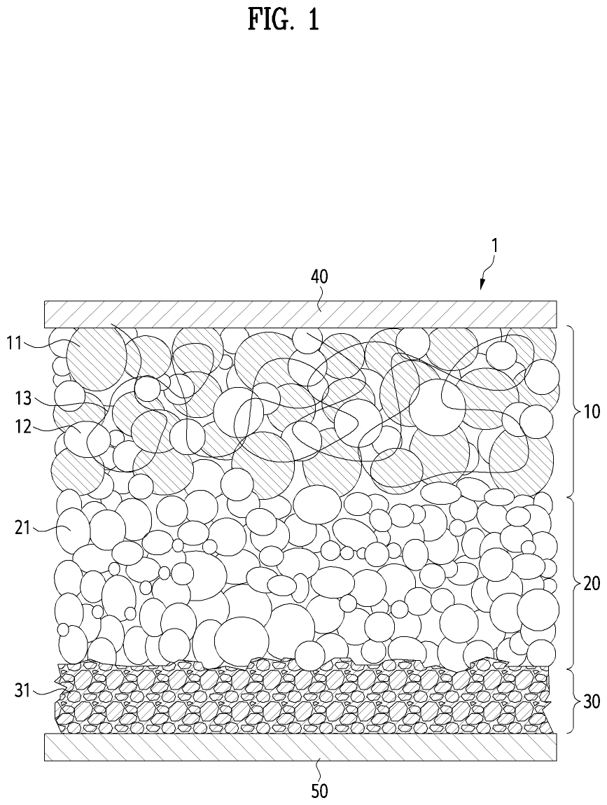

As described above with reference to FIG. 1, the positive electrode layer 10 includes a positive electrode active material (a positive electrode material or a cathode material) 11. In the case of a lithium-ion battery, the positive electrode material 11 contains a large amount of lithium ions.

Unlike liquid batteries, in all-solid-state batteries, mobile lithium participating in reversible reactions is consumed due to electrochemical side reactions during initial charging and discharging. As charging and discharging are repeated, the number of effective lithium ions rapidly decreases, leading to reduction in electrode energy.

Accordingly, as the size of the particles of the positive electrode active material 11 decreases, voids are likely to be formed between the particles of the positive electrode active material 11 and the particles of the solid electrolyte 12. This issue may be referred to as an interfacial issue.

During charging and discharging, lithium ions (Lit) are generated in the positive electrode active material (positive electrode material) 11 and migrate through the solid electrolyte 12. As charging and discharging are repeated, voids may be formed between the positive electrode material 11 and the solid electrolyte 12. These voids may increase in size as charging and discharging are repeated.

In liquid batteries, such voids may be easily filled. However, in all-solid-state batteries, because the electrolyte is in a solid state, it may be difficult to fill such voids. Accordingly, the migration of lithium ions may be hindered, leading to increase in resistance.

In addition, as these voids gradually grow and become more difficult to fill, the overall volume of the battery 1a may increase, as shown in FIG. 3.

In the all-solid-state battery 1 or 1a, the positive electrode layer 10 occupies a relatively large portion of the overall volume. Accordingly, as charging and discharging are repeated, voids may increase in size, primarily causing the positive electrode layer 10 to increase in volume, which may lead to increase in the overall volume of the all-solid-state battery 1 or 1a, as shown in FIG. 3. Such volume expansion typically occurs in a direction toward the positive electrode layer 10. That is, the volume expansion of the positive electrode layer 10 may generally occur in a direction toward the first electrode (positive electrode) 40.

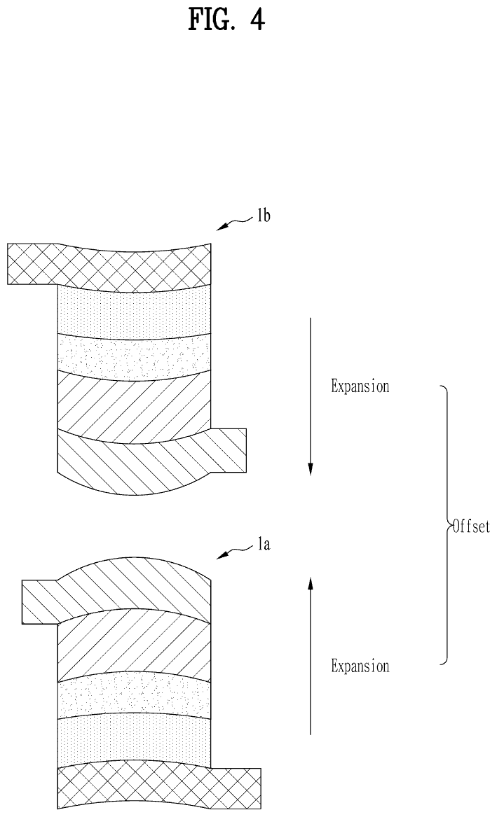

FIG. 4 is a conceptual view showing an all-solid-state battery according to an embodiment of the present disclosure.

Referring to FIG. 4, a concept for addressing the above issues caused by the formation of voids in the entire all-solid-state batteries 1a and 1b is schematically shown.

As described above, volume expansion typically occurs in a direction toward the positive electrode layer 10. That is, the volume expansion of the positive electrode layer 10 may generally occur in a direction toward the first electrode (positive electrode) 40.

Therefore, according to an embodiment of the present disclosure, a plurality of unit all-solid-state batteries 1a and 1b may be configured such that their respective volume expansions occur toward each other, thereby allowing the volume expansions to be offset.

For example, a first all-solid-state battery 1a and a second all-solid-state battery 1b may be configured to face each other. In detail, if the positive electrode layer of the first all-solid-state battery 1a and the positive electrode layer of the second all-solid-state battery 1b are disposed to face each other, the all-solid-state batteries 1a and 1b may apply pressure to each other due to their respective volume expansions, thereby allowing the volume expansions to be offset. Furthermore, if the all-solid-state batteries 1a and 1b apply pressure to each other due to their respective volume expansions, voids formed during charging and discharging may be eliminated or reduced by such pressure.

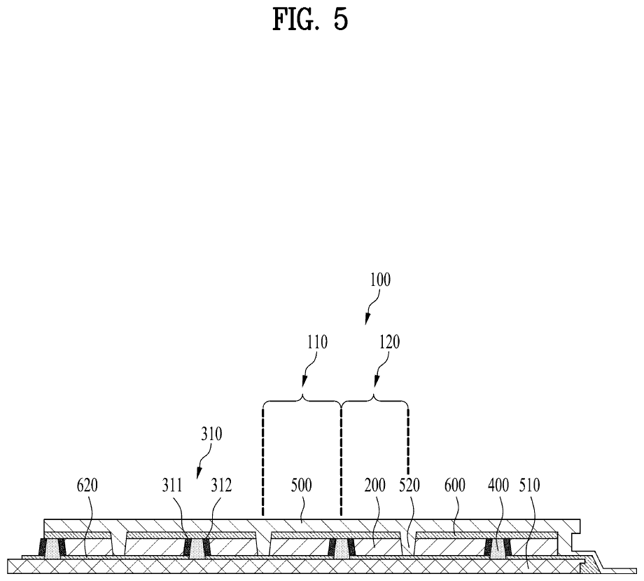

FIG. 5 is a cross-sectional view showing an all-solid-state battery according to an embodiment of the present disclosure.

Referring to FIG. 5, an all-solid-state battery 100 using a solid electrolyte according to an embodiment of the present disclosure may include a first electrode layer 500 and a second electrode layer 510 disposed opposite the first electrode layer 500.

The first electrode layer 500 and the second electrode layer 510, which are disposed opposite each other, may have a relatively large area compared to a distance therebetween. Although the cross-sections thereof are illustrated in FIG. 5, the first electrode layer 500 and the second electrode layer 510, which are disposed opposite each other, may have a square or rectangular shape. In addition, the configuration shown in FIG. 5 may be a portion of the entire all-solid-state battery 100.

A first battery region 110 and a second battery region 120, which are adjacent to each other, may be defined between the first electrode layer 500 and the second electrode layer 510. A positive electrode layer 200 may be disposed in the first battery region 110 and the second battery region 120.

As shown, the first battery region 110 and the second battery region 120 may be repeatedly provided in a direction parallel to the first electrode layer 500 or the second electrode layer 510.

In this case, a combination of the first battery region 110 and the second battery region 120 may be defined by first partition walls 520 extending from one of the first electrode 500 and the second electrode 510.

In this manner, the first partition walls 520 may divide a space between the first electrode layer 500 and the second electrode layer 510 in one direction. In this case, the first battery region 110 may be defined on one side of each of the first partition walls 520, and the second battery region 120 may be defined on the other side of each of the first partition walls 520. In addition, the first battery region 110 and the second battery region 120 may be filled with the positive electrode layer 200.

In an exemplary embodiment, referring to FIG. 5, the first partition walls 520 may extend from the first electrode 500. That is, the first partition walls 520 may be disposed at regular intervals on the first electrode 500. In one example, the first partition walls 520 may protrude in a direction perpendicular to the planar direction of the first electrode 500.

Referring to FIG. 5, a combination or a pair of the first battery region 110 and the second battery region 120 may be disposed between the first partition walls 520 adjacent to each other. Because the positive electrode layer 200 is disposed in the first battery region 110 and the second battery region 120, expansion of the positive electrode layer 200 caused by charging and discharging may be offset. This will be described in detail later.

Meanwhile, a negative electrode material (or an anode material) 400 may be disposed between the first battery region 110 and the second battery region 120. The negative electrode material 400 may be disposed in the form of a partition wall between the first electrode layer 500 and the second electrode layer 510. For example, the negative electrode material 400 may have the same meaning as the negative electrode layer described above. Accordingly, at least one of the first battery region 110 or the second battery region 120 may be defined between the negative electrode material 400 and the first partition walls 520.

As described above, in the exemplary embodiment, a combination of the first battery region 110 and the second battery region 120 may be disposed between the first partition walls 520, and the negative electrode material 400 in the form of a partition wall may be disposed between the first battery region 110 and the second battery region 120 to separate the first battery region 110 and the second battery region 120. The first battery region 110 and the second battery region 120, which are adjacent to each other, may be disposed symmetrically with each other with the partition wall-shaped negative electrode material 400 interposed therebetween. In addition, the first battery region 110 and the second battery region 120 may be repeatedly disposed in the planar direction of the first electrode layer 500 and the second electrode layer 510.

Due to the above-described structure of the battery, stress generated during charging and discharging may be offset in at least one of the first partition wall 520 or the partition wall-shaped negative electrode material 400.

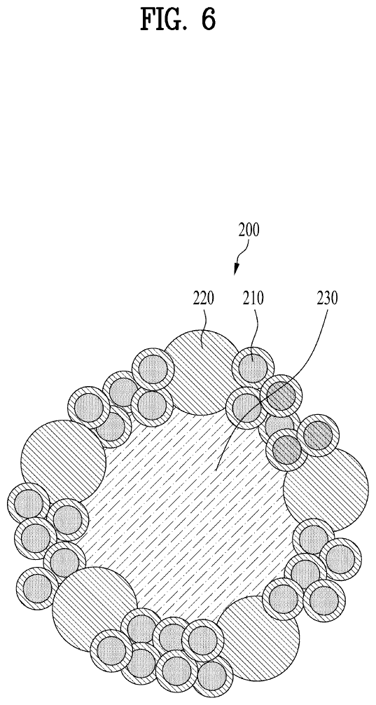

In addition, electrolyte layers 310 may be disposed on the negative electrode material 400. That is, electrolyte layers 311 and 312 may be disposed on at least one side surface of the negative electrode material 400. In detail, a first electrolyte layer 311 may be disposed on a first surface of the partition wall-shaped negative electrode material 400, and a second electrolyte layer 312 may be disposed on a second surface of the negative electrode material 400. In this case, the positive electrode layer 200 may be in contact with the electrolyte layers 310. In addition, the positive electrode layer 200 may include a positive electrode material 210 (see FIG. 6) that is in contact with the electrolyte layers 310.

Meanwhile, in the above-described structure, an insulating adhesive layer 600 may be disposed between the first electrode layer 500 and the negative electrode material 400. That is, the insulating adhesive layer 600 may be disposed on a lower surface of the first electrode layer 500. In other words, the first electrode layer 500 and the positive electrode layer 200 may be insulated from each other by the insulating adhesive layer 600. The insulating adhesive layer 600 may be in contact with the first partition walls 520.

In addition, an insulating layer 620 may be disposed on an upper surface of the second electrode layer 510. The insulating layer 620 may be in contact with the first partition walls 520. Accordingly, the second electrode layer 510 and the positive electrode layer 200 may be insulated from each other by the insulating layer 620.

Accordingly, one side of the positive electrode layer 200 may be in contact with the first partition wall 520 connected to the first electrode layer 500, and the other side of the positive electrode layer 200 may be in contact with the electrolyte layer 310 disposed on the negative electrode material 400.

Meanwhile, the structure associated with the first electrode layer 500 and the structure associated with the second electrode layer 510 may be separately fabricated and then bonded to each other. In this case, the insulating adhesive layer 600 may allow these upper and lower structures to be adhered to each other and maintained in an adhered state. This will be described in detail later.

FIG. 6 is a cross-sectional view showing the positive electrode layer of the all-solid-state battery according to an embodiment of the present disclosure.

Referring to FIG. 6, the positive electrode layer 200 may include a positive electrode material 210 and an electrolyte 220. In an exemplary embodiment, at least one of the electrolyte 220 or the positive electrode material 210 may be disposed on an elastic core 230. The elastic core 230 may include polymer particles.

The elastic core 230 may be elastically deformed in response to expansion and contraction of the positive electrode material 210 caused by charging and discharging.

The electrolyte 220 may have a thickness sufficient to cover an outer surface of the elastic core 230. As such, the positive electrode material 210 and the electrolyte 220 may continuously cover the outer surface of the elastic core 230.

Due to the configuration of the elastic core 230, the likelihood of void formation between the positive electrode material 210 and the electrolyte 220 in the positive electrode layer 200 may be significantly reduced, thereby addressing interfacial issues that commonly occur in all-solid-state batteries.

In other words, in a typical all-solid-state battery, voids are likely to be formed between the positive electrode material 210 and the electrolyte 220 during charging and discharging, which may lead to increase in interfacial resistance. However, due to the elasticity of the elastic core 230, contact between the positive electrode material 210 and the electrolyte 220 may be secured and maintained, thereby significantly addressing such interfacial issues.

When external force is applied or deformation occurs, the elastic core 230 may be compressed and reduced in size due to the elasticity of the elastic core 230. During this process, contact between the positive electrode material 210 and the electrolyte 220 may be maintained.

In addition, when the externally applied force is removed or reduced, the elastic core 230 may recover an original size thereof, thereby maintaining contact between the positive electrode material 210 and the electrolyte 220.

Such a case in which the externally applied force is removed or reduced may occur when the size of the positive electrode material 210 decreases due to the generation of lithium ions. This may also occur when ions containing lithium ions are released from the positive electrode material 210.

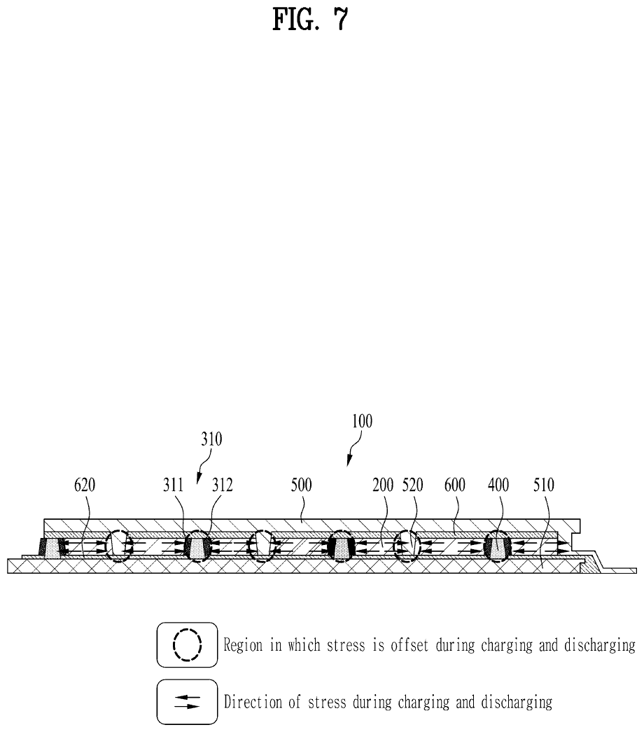

FIG. 7 is a cross-sectional view showing a stress offset process in the all-solid-state battery according to an embodiment of the present disclosure.

As described above, in the all-solid-state battery 100, expansion and contraction may occur in the positive electrode layer 200 during charging and discharging, which may act as stress. In addition, during such a process, voids may be formed between the positive electrode material 210 and the electrolyte 220, which may be included in the positive electrode layer 200, and this phenomenon may lead to expansion of the all-solid-state battery 100.

Referring to FIG. 7, directions in which stress is generated during charging and discharging in the all-solid-state battery 100 according to an embodiment of the present disclosure are indicated by arrows. In FIG. 7, the arrows represent stress primarily caused by expansion resulting from the formation of voids. If contraction occurs in the positive electrode layer 200 during charging and discharging, the directions of arrows may be opposite those shown in FIG. 7.

During charging and discharging of the all-solid-state battery 100, stress may act on at least one of the first partition wall 520 or the partition wall-shaped negative electrode material 400. As described above, during charging and discharging of the all-solid-state battery 100, stress may be generated primarily by the action of the positive electrode layer 200. This stress may act in a direction parallel to the first electrode layer 500 and the second electrode layer 510. Accordingly, the stress may act on at least one of the first partition wall 520 or the partition wall-shaped negative electrode material 400.

In this case, the stress generated in the all-solid-state battery 100 during charging and discharging may be offset between the battery regions 110 and 120 adjacent to each other. In detail, the stress generated in the first battery region 110 and the stress generated in the second battery region 120 may offset each other. That is, the stress may act on at least one of the first partition wall 520 or the partition wall-shaped negative electrode material 400 in opposite directions and may be offset.

In more detail, the stress generated in the first battery region 110 may act toward the second battery region 120, and the stress generated in the second battery region 120 may act toward the first battery region 110. Accordingly, the stress generated in the first battery region 110 and the stress generated in the second battery region 120 may offset each other.

Through this process, the directions of expansion may face each other, and accordingly, voids between the positive electrode material 210 and the electrolyte 220, which may be included in the positive electrode layer 200, may be eliminated or reduced.

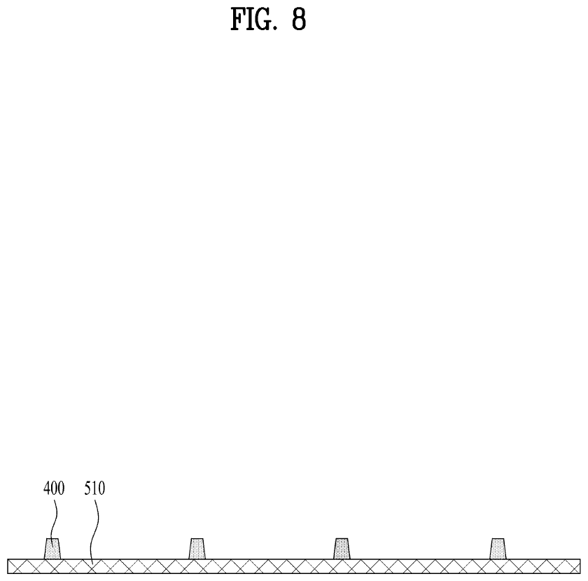

FIGS. 8 to 14 are schematic cross-sectional views showing a process of manufacturing the all-solid-state battery according to an embodiment of the present disclosure.

Hereinafter, the process of manufacturing the all-solid-state battery according to an embodiment of the present disclosure will be described in detail with reference to FIGS. 8 to 14.

As described above, the structure associated with the first electrode layer 500 (upper structure 102) and the structure associated with the second electrode layer 510 (lower structure 101) may be separately fabricated and then bonded to each other.

First, the structure associated with the second electrode layer 510 (lower structure 101) will be described with reference to FIGS. 8 to 10.

Referring to FIG. 8, the partition wall-shaped negative electrode materials 400 may be formed on the second electrode layer 510. The partition wall-shaped negative electrode materials 400 may be formed at regular intervals on the second electrode layer 510. Accordingly, the negative electrode materials 400 may be repeatedly disposed in the planar direction of the second electrode layer 510.

The interval between the partition wall-shaped negative electrode materials 400 may correspond to the width of a region including a combination of the first battery region 110 and the second battery region 120.

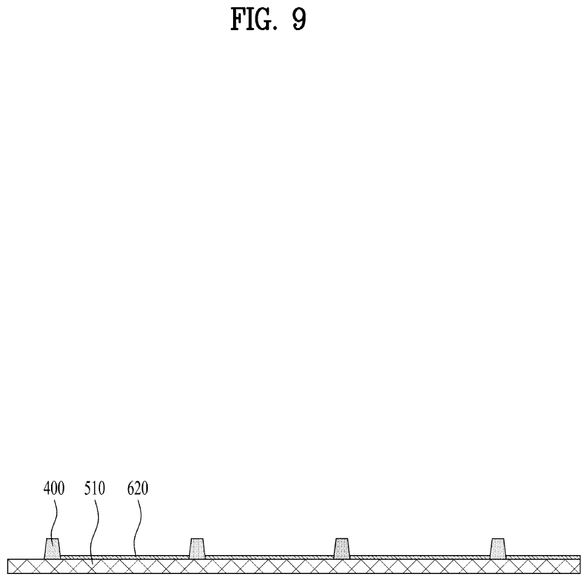

Subsequently, referring to FIG. 9, the insulating layer 620 may be formed on the second electrode layer 510. The insulating layer 620 may prevent electrical contact between the second electrode layer 510 and the positive electrode layer 200.

The insulating layer 620 may be formed in regions on the second electrode layer 510 that correspond to the first battery region 110 and the second battery region 120.

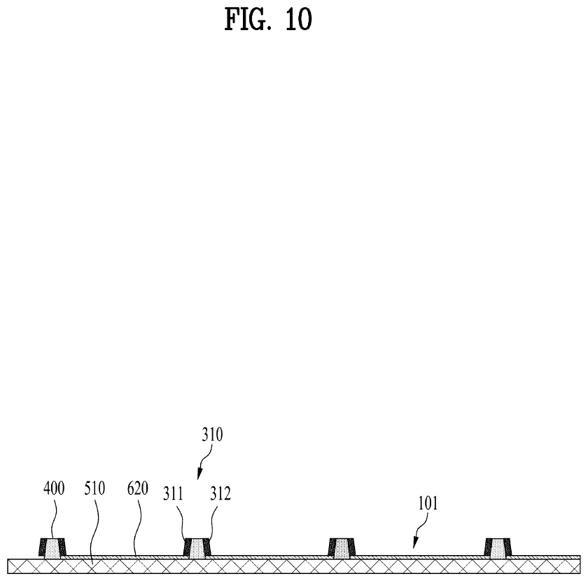

Subsequently, referring to FIG. 10, the electrolyte layers 310 may be formed on both surfaces of the partition wall-shaped negative electrode material 400. In detail, the first electrolyte layer 311 may be formed on a first surface of the partition wall-shaped negative electrode material 400, and the second electrolyte layer 312 may be formed on a second surface of the negative electrode material 400.

Through the above process, the lower structure 101 associated with the second electrode layer 510 may be fabricated.

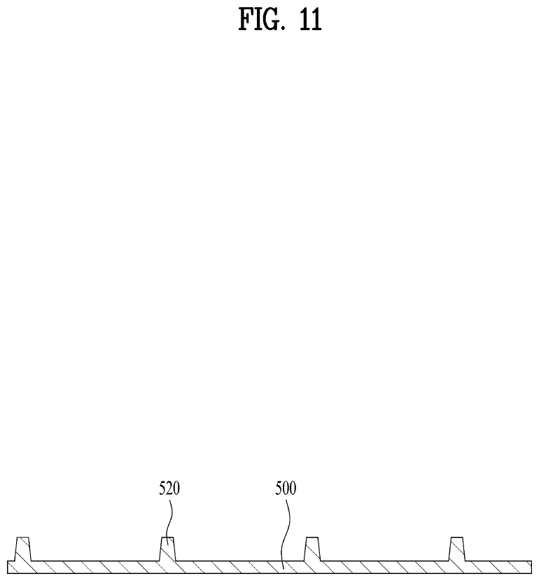

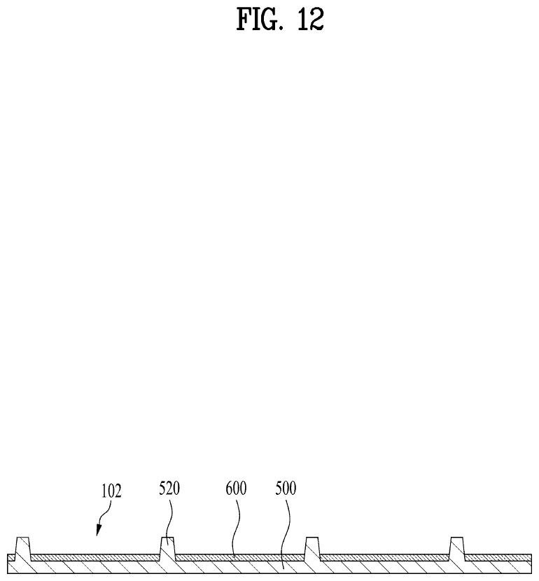

Subsequently, the structure associated with the first electrode layer 500 (upper structure 101) will be described with reference to FIGS. 11 and 12.

Referring to FIG. 11, the first electrode layer 500 including the first partition walls 520 may be formed. In detail, the first electrode layer 500 may be formed such that the first partition walls 520 are disposed at regular intervals. The first partition walls 520 may be formed to extend in one direction.

As such, the first partition walls 520 may be repeatedly disposed in the planar direction of the first electrode layer 500. The interval between the first partition walls 520 may correspond to the width of the region including a combination of the first battery region 110 and the second battery region 120.

Subsequently, referring to FIG. 12, the insulating adhesive layer 600 may be formed on the first electrode layer 500. The insulating adhesive layer 600 may prevent electrical contact between the first electrode layer 500 and the positive electrode layer 200.

The insulating adhesive layer 600 may be formed in regions on the second electrode layer 510 that correspond to the first battery region 110 and the second battery region 120.

Through the above process, the upper structure 102 associated with the first electrode layer 500 may be fabricated.

The insulating adhesive layer 600 may allow the lower structure 101 and the upper structure 102 to be adhered to each other and maintained in an adhered state. That is, the lower structure 101 and the upper structure 102 may be fixed by the insulating adhesive layer 600.

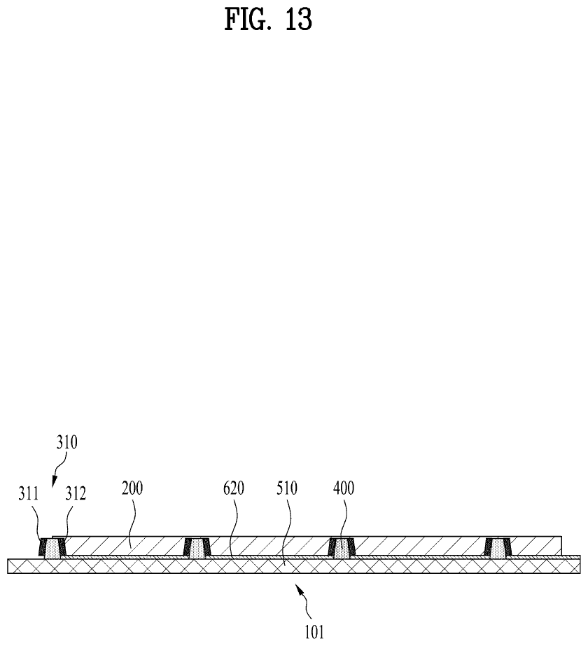

Referring to FIG. 13, in the lower structure 101, the first battery region 110 and the second battery region 120, which are defined by the partition wall-shaped negative electrode materials 400, may be filled with the positive electrode layer 200. As described above, the first electrolyte layer 311 may be disposed on the first surface of the partition wall-shaped negative electrode material 400, and the second electrolyte layer 312 may be disposed on the second surface of the negative electrode material 400. The positive electrode layer 200 may be disposed in contact with the electrolyte layers 311 and 312.

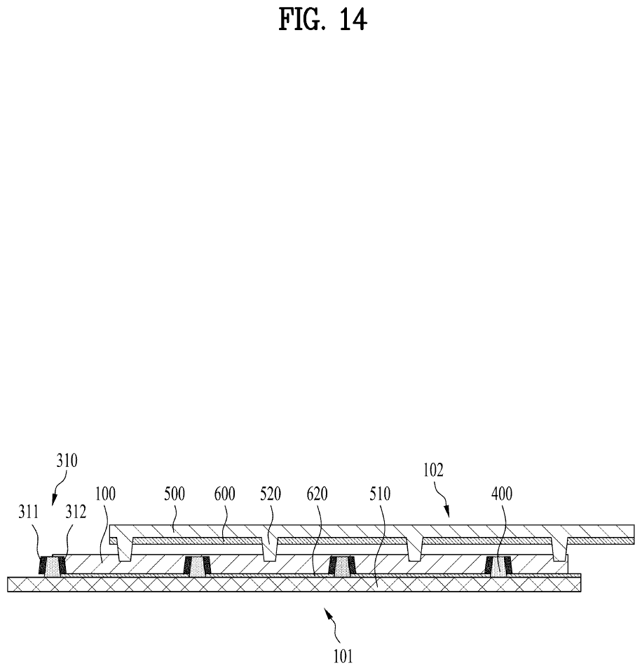

Referring to FIG. 14, the upper structure 102 described above may be bonded to the lower structure 101. In this case, the bonding may be performed such that each of the first partition walls 520 of the upper structure 102 is disposed between two negative electrode materials 400. In one example, the upper structure 102 may be bonded to the lower structure 101 such that each of the first partition walls 520 is disposed at a central position between two adjacent ones of the negative electrode materials 400.

In this process, the first partition walls 520 may penetrate the positive electrode layer 200 to come into contact with the insulating layer 620 of the lower structure 101, and the upper portions of the negative electrode materials 400, the electrolyte layers 310, and the positive electrode layer 200 may come into contact with and be fixed to the insulating adhesive layer 600.

In this manner, when the upper structure 102 is bonded to the lower structure 101, the all-solid-state battery 100 having the structure shown in FIG. 5 may be completed.

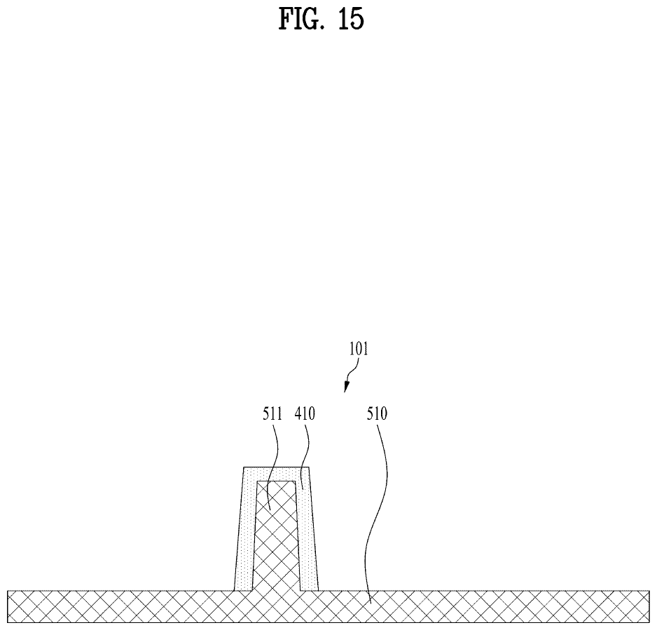

FIG. 15 is a schematic cross-sectional view showing a portion of an all-solid-state battery according to another embodiment of the present disclosure.

The second electrode layer 510 may include an upwardly extending portion, or a second partition wall 511 made of the same material as the second electrode layer 510 may be formed on the second electrode layer 510. In addition, a negative electrode material 410 may be formed on the surface of the second partition wall 511.

That is, instead of using the partition wall-shaped negative electrode material 400 described above, the negative electrode material 410 may be formed on the surface of the second partition wall 511.

As such, the negative electrode material 410 may be disposed on the second partition wall 511 connected to the second electrode layer 510.

With this structure, the efficiency of collecting electrons generated in the positive electrode layer 200 to the second electrode layer (current collector) 510 through the negative electrode material 410 may be improved.

The above description is provided merely by way of example to illustrate the present invention, and it will be understood by those of ordinary skill in the art that various modifications and changes may be made without departing from the essential features of the invention.

Accordingly, the embodiments disclosed herein are intended to describe, not to limit, the scope of the invention, and the scope of the invention should not be construed as being limited by these embodiments.

The scope of protection of the present invention shall be defined by the following claims, and all modifications or equivalents falling within the scope of the claims shall be construed as being included within the scope of the invention.

### INDUSTRIAL APPLICABILITY

According to the present disclosure, an all-solid-state battery that is a secondary battery using a solid electrolyte may be provided.

1. An all-solid-state battery using a solid electrolyte, the all-solid-state battery comprising:
a first electrode layer;
a second electrode layer disposed opposite the first electrode layer;
a first battery region defined between the first electrode layer and the second electrode layer;
a second battery region defined between the first electrode layer and the second electrode layer at a position adjacent to the first battery region; and
a positive electrode layer disposed in the first battery region and the second battery region.

2. The all-solid-state battery of claim 1, wherein the first battery region and the second battery region are repeatedly provided in a direction parallel to the first electrode layer or the second electrode layer.

3. The all-solid-state battery of claim 2, wherein a pair of the first battery region and the second battery region is defined by a first partition wall extending from one of the first electrode layer and the second electrode layer.

4. The all-solid-state battery of claim 3, wherein the first partition wall is formed to be connected to the first electrode layer.

5. The all-solid-state battery of claim 1, comprising a negative electrode material disposed between the first battery region and the second battery region.

6. The all-solid-state battery of claim 5, wherein the negative electrode material is disposed in a form of a partition wall between the first electrode layer and the second electrode layer.

7. The all-solid-state battery of claim 5, wherein the negative electrode material is disposed on a second partition wall connected to the second electrode layer.

8. The all-solid-state battery of claim 5, wherein at least one of the first battery region or the second battery region is defined between the negative electrode material and the first partition wall.

9. The all-solid-state battery of claim 5, wherein stress generated during charging and discharging of the all-solid-state battery is offset in at least one of the first partition wall or the negative electrode material.

10. The all-solid-state battery of claim 5, comprising an electrolyte layer disposed on at least one side surface of the negative electrode material.

11. The all-solid-state battery of claim 1, wherein the positive electrode layer comprises a positive electrode material in contact with an electrolyte.

12. The all-solid-state battery of claim 11, wherein at least one of the electrolyte or the positive electrode material is disposed on an elastic core.

13. An all-solid-state battery using a solid electrolyte, the all-solid-state battery comprising:
a first electrode layer;
a second electrode layer disposed opposite the first electrode layer;
a first partition wall dividing a space between the first electrode layer and the second electrode layer in one direction;
a first battery region defined on one side of the first partition wall;
a second battery region defined on an opposite side of the first partition wall at a position adjacent to the first battery region; and
a positive electrode layer disposed in the first battery region and the second battery region.

14. The all-solid-state battery of claim 13, wherein the first battery region and the second battery region are repeatedly provided in a direction parallel to the first electrode layer or the second electrode layer.

15. The all-solid-state battery of claim 13, wherein the first partition wall is formed to be connected to the first electrode layer.

16. The all-solid-state battery of claim 13, comprising a negative electrode material disposed between the first battery region and the second battery region.

17. The all-solid-state battery of claim 16, wherein the negative electrode material is disposed in a form of a partition wall between the first electrode layer and the second electrode layer.

18. The all-solid-state battery of claim 16, wherein the negative electrode material is disposed on a second partition wall connected to the second electrode layer.

19. The all-solid-state battery of claim 16, wherein at least one of the first battery region or the second battery region is defined between the negative electrode material and the first partition wall.

20. The all-solid-state battery of claim 16, comprising an electrolyte layer disposed on at least one side surface of the negative electrode material.
